(19) United States
(12) Patent Application Publication
(10) Pub. No.: US 2010/0117915 A1
(43) Pub. Date: May 13, 2010

(54) Weight-Tapered IL Antenna With Slot Meander

(76) Inventors: Aviv Shachar, Ramat-Gan (IL); Yiu Kwong Chan, Vernon Hills, IL (US); Motti Elkobi, Natanya (IL)

Correspondence Address: MOTOROLA, INC., 1303 EAST ALGONQUIN ROAD, IL01/3RD, SCHAUMBURG, IL, 60196, US

(21) Appl. No.: 12/268,125

(22) Filed: Nov. 10, 2008

(51) Int. Cl. H01Q 13/10

(52) U.S. Cl. 343/767

(57) ABSTRACT

An antenna including a main span extending in a first direction, a first arm extending from the main span in a second direction substantially perpendicular to the first direction, a second arm extending from the main span in a third direction substantially opposite the second direction, a disc portion with a center substantially disposed at an intersection of the main span and the second arm, and a slot having a plurality of portions.

### BACKGROUND

The capabilities of mobile communications devices are consistently increasing. Typical modern devices of this type may include multiple transceivers and corresponding antennas for each of the transceivers. These antennas should be designed and oriented so as to optimize performance while minimizing interference among different antennas.

### SUMMARY OF THE INVENTION

The present invention is directed to an antenna including a main span extending in a first direction, a first arm extending from the main span in a second direction substantially perpendicular to the first direction, a second arm extending from the main span in a third direction substantially opposite the second direction, a disc portion with a center substantially disposed at an intersection of the main span and the second arm, and a slot having a plurality of portions.

The present invention is further directed to a device including a first wireless transceiver and a first antenna coupled to the first wireless transceiver. The first antenna includes a main span extending in a first direction, a first arm extending from the main span in a second direction substantially perpendicular to the first direction, a second arm extending from the main span in a third direction substantially opposite the second direction, a disc portion with a center substantially disposed at an intersection of the main span and the second arm, and a slot having a plurality of portions.

### BRIEF DESCRIPTION OF THE DRAWINGS

FIG. 1 shows a partial view of an exemplary mobile communication device according to the present invention.

FIG. 2 shows an exemplary antenna with a slot meander according to the present invention.

### DETAILED DESCRIPTION

The exemplary embodiments of the present invention may be further understood with reference to the following description and the appended drawings, wherein like elements are referred to with the same reference numerals. The exemplary embodiments describe antenna arrangements that reduce interference and improve isolation of antennas located in close physical proximity to one another while operating in different frequency bands.

Modern mobile communication devices may typically include multiple transceivers. Each such transceiver may be used in conjunction with a different communications protocol (e.g., cellular, WiFi, Bluetooth, etc.), and may be used for varying tasks or types of communication. For example, one transceiver may be used for voice communications while another may be used for data communications; alternately, one transceiver may be used for short-range data communications while another may be used for long-range data communications; those of skill in the art will understand that these divisions of labor are only exemplary and that various others are possible.

Such transceivers may share some system resources with one another. For example, they may be located on the same printed circuit board, may draw power from the same source (e.g., a battery, line power, etc.), may receive instructions from the same processor, etc. However, because of the varying needs of transceivers engaged in different types of communications, each transceiver may typically require its own antenna designed to specifications appropriate to the transceiver. When designing devices with multiple transceivers and multiple corresponding antennas, one important design concern is to maximize the isolation between the antennas, and thus minimize signal interference and improve the performance of the corresponding transceivers.

One common class of mobile devices includes a first transceiver for cellular communications and a second transceiver for WiFi (e.g., 802.11 a/b/g/n) communications. In the design of such devices, it is desirable for the two transceivers to be able to operate simultaneously without interference. This presents a significant challenge, especially in light of the fact that such devices must place antennas, as well as all other required components, in a limited amount of space. While many antenna designs are known in the art (e.g., inverted L-antenna, inverted F-antenna, monopole disc antenna, J-antenna, etc.) and may provide good signal radiation, use of existing antenna designs in conjunction in a single device with multiple transceivers typically results in unsatisfactory levels of isolation.

Various techniques exist to improve the isolation performance of antennas located in close physical proximity to one another. In one example, a weight-tapered inverted-L (“IL”) antenna with a disc-shaped portion, typically used for cellular communications, may be used in conjunction with a dual band inverted F-antenna, typically used for WiFi communications. The antennas may be placed perpendicular to one another in order to minimize interference. In key frequency ranges, this antenna selection and arrangement may yield an isolation of −20 dB. However, in order to suppress noise floor jamming that may be generated by WiFi signals, an isolation of at least −30 dB is desirable.

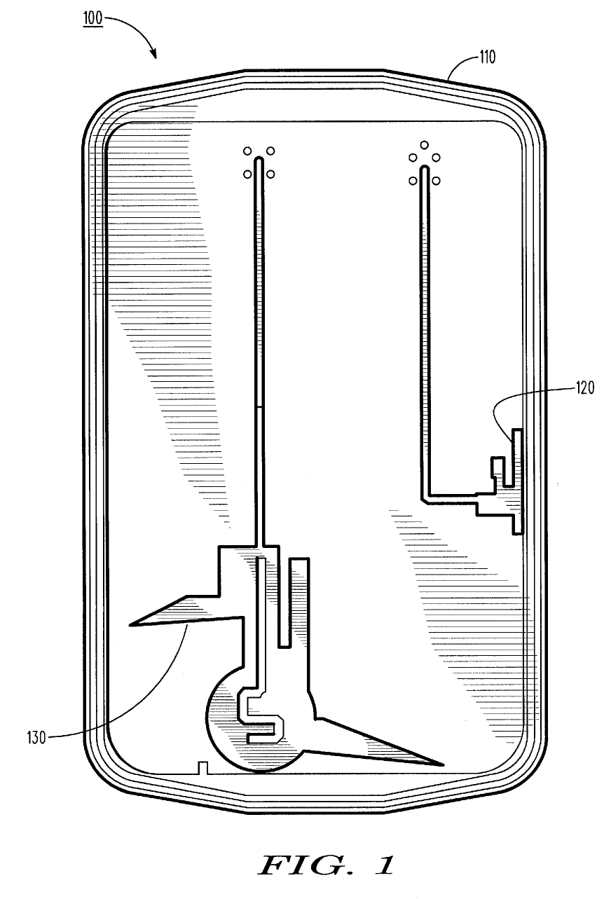

The exemplary embodiment addresses this deficiency by providing a suitable level of isolation. FIG. 1 illustrates an exemplary device 100 according to the present invention. The device 100 is shown with part of the casing 110 removed in order to illustrate internal components. The device 100 includes a first antenna 120 and a second antenna 130. The first antenna 120 may be a dual-band inverted F-antenna as described above, and may be used to send and receive signals by a first transceiver (e.g., a WiFi transceiver, etc.), not shown.

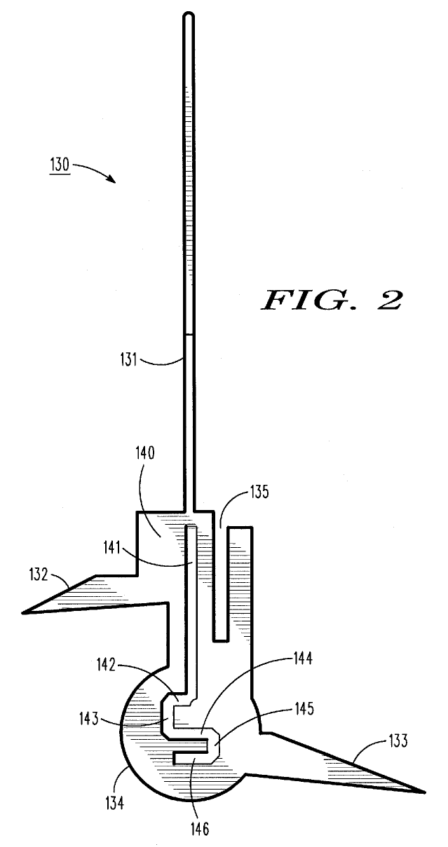

The second antenna 130 may be oriented perpendicular to the first antenna 120 (e.g., as illustrated in FIG. 1, the main portion of the first antenna 120 is oriented horizontally, while the main portion of the second antenna 130 is oriented vertically) in order to take advantage of the benefits of such an orientation as described above. The first antenna 120 and the second antenna 130 may share the same ground plane. FIG. 2 shows the second antenna 130 in more detail. As can be seen, the basic profile of the second antenna 130 is similar to a weight-tapered IL antenna with a disc-shaped portion. The second antenna 130 includes a main span 131, a first arm 132, a second arm 133, a disc 134 and a first slot 135. In this exemplary embodiment, the second antenna 130 may be 91 mm in width and 143 mm in length, and that the first slot 135 may be 2.5 mm in width and 19 mm in length, though those of skill in the art will understand that the precise dimensions may vary in other embodiments.

The second antenna 130 further includes a second slot 140, also referred to as a “slot meander,” which may be 2 mm in width. The second slot 140 includes a first portion 141 that extends along the main span 131 and may be 30.5 mm in length; a second portion 142 that extends toward the first arm 132 and may be 6 mm in length; a third portion 143 that extends in the same direction as the first portion 141 and may be 8 mm in length; a fourth portion 144 that extends toward the second arm 133 and may be 10 mm in length; a fifth portion 145 that extends in the same direction as the first portion 141 and the third portion 143 and may be 6 mm in length; and a sixth portion 146 that extends in the same direction as the second portion 142 and may be 7.9 mm in length. The corners of the second slot 140 where the portions intersect may be plain intersections, diagonally chamfered (e.g., at a 45 degree angle), curved, etc. As stated above, those of skill in the art will understand that the dimensions of the second slot 140 and its portions 141-146 provided above are intended to be both approximate and exemplary and that other embodiments may be of varying size and orientation.

The performance achieved by the second antenna 130 may be comparable to that of a standard weight-tapered IL antenna with a disc-shaped portion. The second antenna 130 may have an omni-directional radiation pattern and may have an efficiency of at least 70% in cellular bands (e.g., AMPS, GSM, DCS, PCS, UMTS, etc.). The first antenna 120 may have an efficiency of at least 85% in WiFi bands. The second antenna 130 may also achieve a bandwidth of 23% in high frequency bands, an improvement over standard monopole/dipole antennas, which typically achieve a bandwidth of 5% to 12%. This improvement may be achieved due to the tapered shape of arms 132 and 133, which may be sized to match the frequency of the signals that they receive.

Additionally, for signals in the frequency band from 2.11 GHz to 2.17 GHz (e.g., the UMTS band), the second antenna 130 with the slot meander may achieve an isolation of −30 dB, an improvement of 10 dB over prior implementations described above. Further optimizations, such as using the housing 110 of the device 100 for capacitance, may achieve further gains in isolation, on the order of −34 to −40 dB in the same frequency band as described above.

It will be apparent to those skilled in the art that various modifications may be made in the present invention, without departing from the spirit or the scope of the invention. For example, the principles described may be applied to antennas adapted to send and receive signals in various frequency bands and for various purposes. Thus, it is intended that the present invention cover modifications and variations of this invention provided they come within the scope of the appended claims and their equivalents.

What is claimed is:

1. An antenna comprising:
a main span extending in a first direction;
a first arm extending from the main span in a second direction substantially perpendicular to the first direction;
a second arm extending from the main span in a third direction substantially opposite the second direction;
a disc portion with a center substantially disposed at an intersection of the main span and the second arm; and
a slot comprising a plurality of portions.

2. The antenna of claim 1, wherein the slot comprises a first portion extending in the first direction.

3. The antenna of claim 2, wherein the slot further comprises a second portion extending in the second direction.

4. The antenna of claim 3, wherein the slot further comprises a third portion extending in the first direction.

5. The antenna of claim 4, wherein the slot further comprises a fourth portion extending in the third direction.

6. The antenna of claim 5, wherein the slot further comprises a fifth portion extending in the first direction.

7. The antenna of claim 6, wherein the slot further comprises a sixth portion extending in the second direction.

8. The antenna of claim 1, further comprising:
a second slot extending along the main span in the first direction.

9. A device, comprising:
a first wireless transceiver; and
a first antenna coupled to the first wireless transceiver, the first antenna comprising:
a main span extending in a first direction;
a first arm extending from the main span in a second direction substantially perpendicular to the first direction;
a second arm extending from the main span in a third direction substantially opposite the second direction;
a disc portion with a center substantially disposed at an intersection of the main span and the second arm; and
a slot comprising a plurality of portions.

10. The device of claim 9, wherein the slot comprises a first portion extending in the first direction.

11. The device of claim 10, wherein the slot further comprises a second portion extending in the second direction.

12. The antenna of claim 11, wherein the slot further comprises a third portion extending in the first direction.

13. The device of claim 12, wherein the slot further comprises a fourth portion extending in the third direction.

14. The device of claim 12, wherein the slot further comprises a fifth portion extending in the first direction.

15. The device of claim 14, wherein the slot further comprises a sixth portion extending in the second direction.

16. The device of claim 9, further comprising:
a second wireless transceiver; and
a second antenna.

17. The device of claim 16, wherein the second antenna is a dual-band inverted F-antenna.

18. The device of claim 16, wherein the second antenna is oriented in a fourth direction substantially perpendicular to the first direction.

19. The device of claim 16, wherein the first antenna and the second antenna share a ground plane.
